(19) United States
(12) Patent Application Publication
(10) Pub. No.: US 2020/0358046 A1
(43) Pub. Date: Nov. 12, 2020

(54) ANTI-EXPLOSION BATTERY CAP

(71) Applicant: Cheng Uei Precision Industry Co., Ltd., New Taipei City (TW)

(72) Inventors: CHIH-HSIEN CHIANG, New Taipei City (TW); SHENG-NAN YU, New Taipei City (TW)

(21) Appl. No.: 16/711,425

(22) Filed: Dec. 11, 2019

(30) Foreign Application Priority Data
May 6, 2019 (CN) 201920639969.1

(51) Int. Cl. H01M 2/04; H01M 2/12

(52) U.S. Cl. CPC H01M 2/0443; H01M 2/1247

(57) ABSTRACT

An anti-explosion battery cap includes a top cover, an anti-explosion slice, a sealing ring and an orifice plate. The anti-explosion slice is connected to the top cover. The sealing ring receives the top cover and the anti-explosion slice, and includes at least a first stop block and at least a second stop block. The first stop block is arranged in an inner side of the sealing ring and extending inwardly to be located below the anti-explosion slice. The second stop block is arranged in the inner side of the sealing ring and extends inwardly to be located below the first stop block. The orifice plate is received in the sealing ring and connected to the anti-explosion slice. The orifice plate is located between the first stop block and the second stop block. Therefore, the anti-explosion battery cap has an ability of anti-short circuit and an optimized structure with constant cost.

### BACKGROUND OF THE INVENTION

### 1. Field of the Invention

The present application is based on, and claims priority from, China application number 201920639969.1, filed May 6, 2019, the disclosure of which is hereby incorporated by reference herein in its entirety. The present invention generally relates to an anti-explosion battery cap, and more particularly to an anti-explosion battery cap having an ability of anti-short circuit with an optimized structure that maintains a constant cost.

### 2. Related Art

Lithium-ion battery has been widely applied in digital products due to its high safety performance, high nominal voltage, long lifespan, non-memory effect, high capacity and environmental friendliness with non-toxicity and non-pollution.

In general, cylindrical lithium-ion battery has an anti-explosion battery cap that consists of a top cover, an anti-explosion slice, a sealing ring and an orifice plate and is used to prevent battery explosion resulted from excessive air pressure inside the lithium-ion battery caused by overcharge, over discharge or high temperature, etc. However, the sealing ring of the current anti-explosion battery cap appears so simple in structure that after the explosion of the anti-explosion slice, the orifice plate unfavourably comes off from the sealing ring and touches with the anti-explosion slice again, which may result in potential risk of short circuit.

Therefore, there is a need to provide an anti-explosion battery cap having an ability of anti-short circuit with an optimized structure that maintains a constant cost.

### SUMMARY OF THE INVENTION

An object of the present invention is to provide an anti-explosion battery cap to overcome the flaws and insufficiency of the state of the art.

To attain this, an anti-explosion battery cap of the present invention includes a top cover, an anti-explosion slice, a sealing ring and an orifice plate. The anti-explosion slice is connected to the top cover. The sealing ring receives the top cover and the anti-explosion slice, and includes at least a first stop block and at least a second stop block. The first stop block is arranged in an inner side of the sealing ring and extending inwardly to be located below the anti-explosion slice. The second stop block is arranged in the inner side of the sealing ring and extends inwardly to be located below the first stop block. The first stop block and the second stop block are arranged in parallel and staggered up and down. The orifice plate is received in the sealing ring and connected to the anti-explosion slice. The orifice plate is located between the first stop block and the second stop block.

Accordingly, the top cover is disposed with a top surface, a bending portion, a first circular ring, a plurality of exhaust holes, an outer edge of the top surface is bended and extended obliquely to form the bending portion, a bottom of the bending portion is extended outwardly and connected to the first circular ring, the first circular ring is parallel to the top surface, the plurality of the exhaust holes form on the bending portion.

Accordingly, the anti-explosion slice is disposed with a first body, an annular groove, a second circular ring and a bent arm, the first body is provided with the annular groove, an outer edge of the first body is extended outwardly to form the second circular ring, an outer edge of the second circular ring is bended and extended upwardly and then bended and extended inwardly to form the bent arm, the bent arm envelops the first circular ring of the top cover.

Accordingly, an inner side of the second circular ring is bended inwardly and extended toward the orifice plate to form the first body, the first body is bulged toward the orifice plate as the arc-shaped plate structure, a centre of the first body is welded on the orifice plate, the annular groove is provided on a surface of the first body facing the orifice plate and formed adjacent to a junction of the first body and the second circular ring.

Accordingly, the sealing ring is disposed with an outer ring, a third circular ring, an inner ring, the first stop block, the second stop block and a positioning convex block, an inner side of the outer ring is attached with an outer side of the bent arm of the anti-explosion slice, a bottom of the outer ring is bended inwardly to form the third circular ring, the third circular ring is abutted against the second circular ring of the anti-explosion slice, an inner side of the third circular ring is extended downwardly to form the inner ring, a top of the inner side of the third circular ring forms the first stop block, the first stop block is abutted against a top surface of the orifice plate, a bottom of an inner side of the inner ring forms the second stop block, the second stop block is abutted against a bottom surface of the orifice plate, an inner side of the outer ring is extended inwardly to form the positioning convex block, the positioning convex block is abutted against the bent arm of the anti-explosion slice.

Accordingly, the orifice plate is disposed with a second body, a blind hole, several solder bumps, the second body is abutted against the first body of the anti-explosion slice, the blind hole is disposed on the second body, the solder bumps are disposed in the blind hole, the solder bumps connect a centre of the first body to the second body.

As above, the anti-explosion battery cap of the present invention provides an optimized structure, by which the first stop block is abutted against the top surface of the orifice plate to realize positioning and fixation between the sealing ring and the orifice plate. After the annular groove breaks itself, the orifice plate is prevented to touch with the anti-explosion slice so as to avoid the short circuit of the anti-explosion battery cap; the second stop block is abutted against the bottom surface of the orifice plate to realize positioning and fixation between the sealing ring and the orifice plate. After the annular groove breaks itself, the first stop block and the second stop block are designed to prevent the orifice plate from coining off from the sealing ring so that the orifice plate can be fixed in the sealing ring without adding insulation sheets (not shown) which may cause the rise in cost. Therefore, the anti-explosion battery cap can be improved in an ability of anti-short circuit with the optimized structure that maintains a constant cost.

### BRIEF DESCRIPTION OF THE DRAWINGS

FIG. 1 is a perspective view showing an anti-explosion battery cap in accordance with the present invention;

FIG. 2 is an exploded perspective view of FIG. 1;

FIG. 3 is a bottom view of FIG. 1; and

FIG. 4 is a cross-sectional view taken along lines IV-IV of FIG. 3.

### DESCRIPTION OF THE PREFERRED EMBODIMENTS

In order to describe the technical contents, structural features, purpose to be achieved and the effectiveness of an anti-explosion battery cap 100 of the present invention, the detailed description is given with schema below.

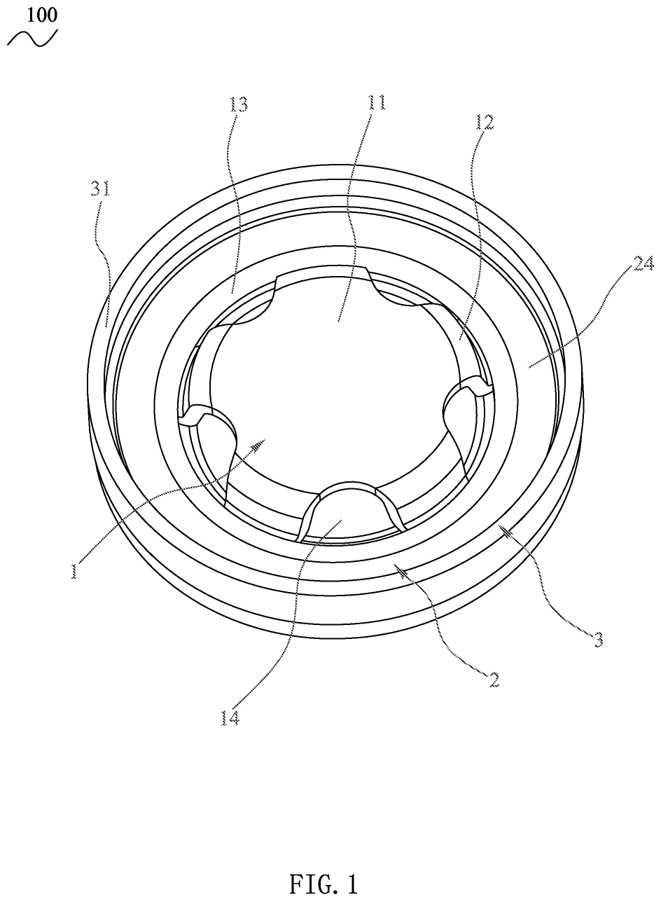

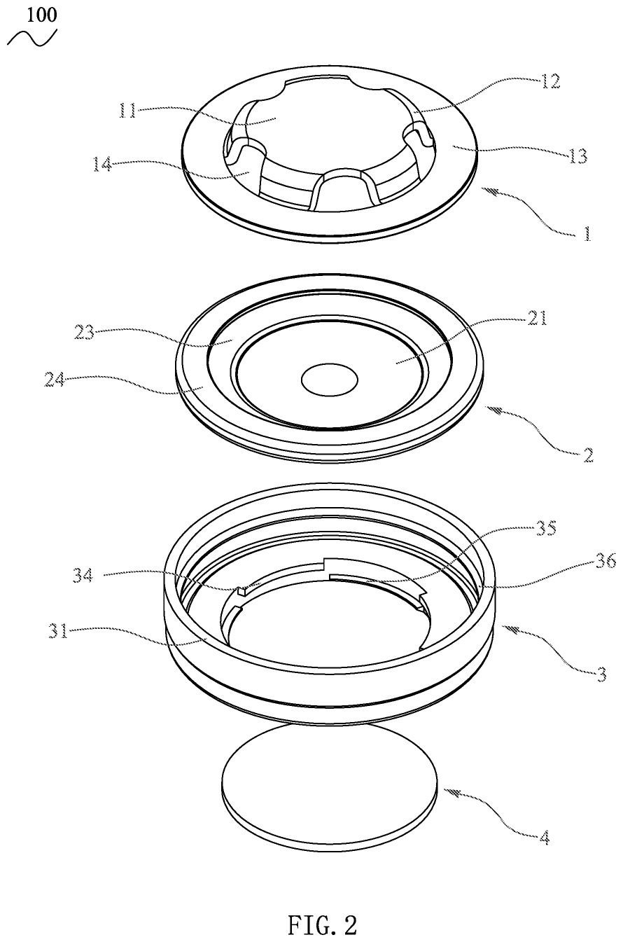

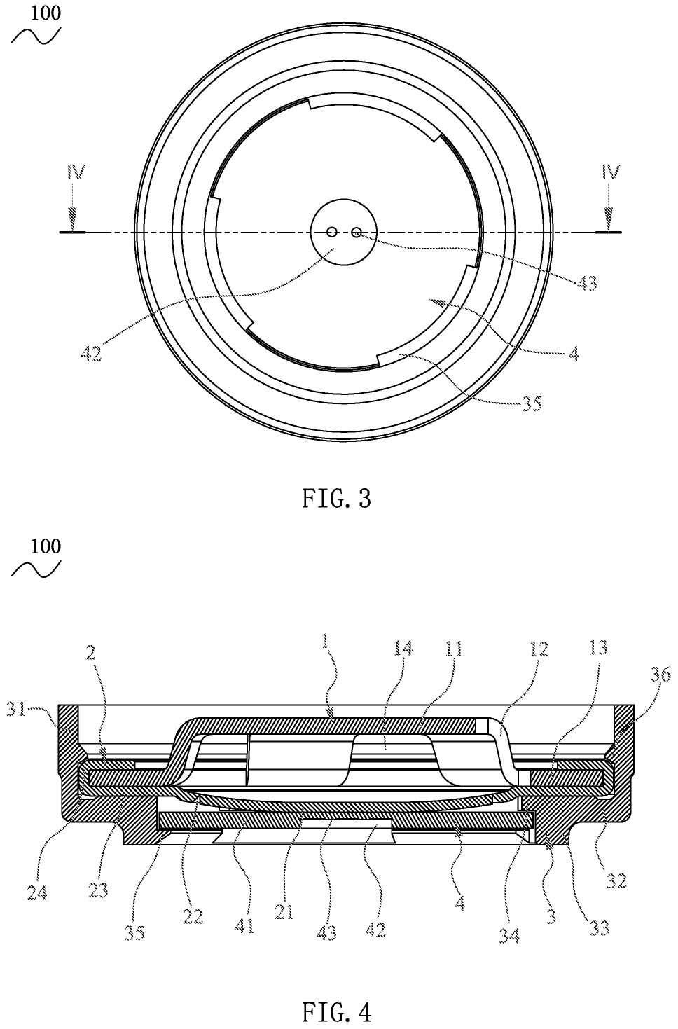

Referring to FIG. 1 through FIG. 4, the anti-explosion battery cap 100 includes a top cover 1, an anti-explosion slice 2, a sealing ring 3 and an orifice plate 4. The top cover 1, the anti-explosion slice 2 and the orifice plate 4 are received in the sealing ring 3 in order from top to bottom.

The top cover 1 is disposed with a top surface 11, a bending portion 12, a first circular ring 13, a plurality of exhaust holes 14. The top surface 11 is of a horizontal plate structure. An outer edge of the top surface 11 is bended and extended obliquely to form the bending portion 12. A bottom of the bending portion 12 is extended outwardly and connected to the first circular ring 13. The first circular ring 13 is of a ring-type structure and is parallel to the top surface 11. The first circular ring 13 is covered by a corresponding component of the anti-explosion slice 2 to realize positioning and fixation between the top cover 1 and the anti-explosion slice 2. The plurality of the exhaust holes 14 form on the bending portion 12. In this embodiment, the top surface 11, the bending portion 12 and the first circular ring 13 are integratedly punch-formed.

The anti-explosion slice 2 is disposed with a first body 21, an annular groove 22, a second circular ring 23 and a bent arm 24. The first body 21 is of an arc-shaped plate structure. The first body 21 is abutted against a corresponding component of the orifice plate 4 to realize positioning and fixation between the anti-explosion slice 2 and the orifice plate 4. The first body 21 is provided with the annular groove 22. When air pressure inside the lithium-ion battery exceeds a design pressure, the annular groove 22 would break itself to release excessive air from the plurality of the exhaust holes 14 of the top cover 1 so as to ensure that battery explosion is not happened. An outer edge of the first body 21 is extended outwardly to form the second circular ring 23. The second circular ring 23 is of a ring-type structure. The second circular ring 23 is abutted against a corresponding component of the sealing ring 3 to realize positioning and fixation between the anti-explosion slice 2 and the sealing ring 3. An outer edge of the second circular ring 23 is bended and extended upwardly and then bended and extended inwardly to form the bent arm 24. The bent arm 24 envelops the first circular ring 13 of the top cover 1 to realize positioning and fixation between the anti-explosion slice 2 and the top cover 1. An outer side of the bent arm 24 is attached with a corresponding component of the sealing ring 3 to realize positioning and fixation between the anti-explosion slice 2 and the sealing ring 3. An upper surface of the bent arm 24 is abutted against a corresponding component of the sealing ring 3 to realize positioning and fixation between the anti-explosion slice 2 and the sealing ring 3.

In this embodiment, an inner side of the second circular ring 23 is bended inwardly and extended toward the orifice plate 4 to form the first body 21. The first body 21 is bulged toward the orifice plate 4 as the arc-shaped plate structure. A centre of the first body 21 forms a welding plane which is welded on the orifice plate 4. The annular groove 22 is provided on a surface of the first body 21 facing the orifice plate 4 and formed adjacent to a junction of the first body 21 and the second circular ring 23.

The sealing ring 3 is disposed with an outer ring 31, a third circular ring 32, an inner ring 33, at least a first stop block 34, at least a second stop block 35 and a positioning convex block 36. The outer ring 31 is of a vertical cylinder structure. An inner side of the outer ring 31 is attached with an outer side of the bent arm 24 of the anti-explosion slice 2 to realize positioning and fixation between the sealing ring 3 and the anti-explosion slice 2. A bottom of the outer ring 31 is bended inwardly to form the third circular ring 32. The third circular ring 32 is of a ring-type structure. The third circular ring 32 is abutted against the second circular ring 23 of the anti-explosion slice 2 to realize positioning and fixation between the sealing ring 3 and the anti-explosion slice 2. An inner side of the third circular ring 32 is extended downwardly to form the inner ring 33. The inner ring 33 is of a vertical cylinder structure. A top of the inner side of the third circular ring 32 is extended inwardly to form the first stop block 34. The first stop block 34 is abutted against a top surface of the orifice plate 4 to realize positioning and fixation between the sealing ring 3 and the orifice plate 4. A bottom of an inner side of the inner ring 33 is extended inwardly to form the second stop block 35. The second stop block 35 is abutted against a bottom surface of the orifice plate 4 to realize positioning and fixation between the sealing ring 3 and the orifice plate 4. An inner side of the outer ring 31 is extended inwardly to form the positioning convex block 36. The positioning convex block 36 is abutted against the bent arm 24 of the anti-explosion slice 2 to realize positioning and fixation between the sealing ring 3 and the anti-explosion slice 2.

The first stop block 34 is abutted against the top surface of the orifice plate 4 to realize positioning and fixation between the sealing ring 3 and the orifice plate 4. After the annular groove 22 breaks itself, the orifice plate 4 is prevented to touch with the anti-explosion slice 2 so as to avoid the short circuit of the anti-explosion battery cap 100. The second stop block 35 is abutted against the bottom surface of the orifice plate 4 to realize positioning and fixation between the sealing ring 3 and the orifice plate 4. After the annular groove 22 breaks itself, the first stop block 34 and the second stop block 35 are designed to prevent the orifice plate 4 from coining off from the sealing ring 3 so as to avoid the short circuit of the anti-explosion battery cap 100 and to maintain a constant cost. In this embodiment, the first stop block 34 is located below the anti-explosion slice 2 and above the orifice plate 4, while the second stop block 35 is located below the orifice plate 4. In another embodiment, there are a plurality of the first stop blocks 34 and a plurality of the second stop blocks 35. The plurality of the first stop blocks 34 and the plurality of the second stop blocks 35 are arranged in parallel and staggered up and down. In practice, the positions of the plurality of the first stop blocks 34 and the plurality of the second stop blocks 35 are interchangeable.

The orifice plate 4 is disposed with a second body 41, a blind hole 42, several solder bumps 43. The second body 41 is abutted against the first body 21 of the anti-explosion slice 2 to realize positioning and fixation between the orifice plate 4 and the anti-explosion slice 2. The blind hole 42 is disposed on the second body 41. The solder bumps 43 are disposed in the blind hole 42. The solder bumps 43 are utilized for connection of the first body 21 and the second body 41. When air pressure inside the lithium-ion battery exceeds a design pressure, the solder bumps 43 rupture and the orifice plate 4 and the anti-explosion slice 2 are separated from a spot where the solder bumps 43 rupture, so the circuit of the battery is cut off and the heating of the battery is avoided. In this embodiment, the blind hole 42 is formed on a surface of the orifice plate 4 back to the anti-explosion slice 2. The solder bumps 43 are utilized to weld the orifice plate 4 to the welding plane of the anti-explosion slice 2.

As above, the anti-explosion battery cap 100 of the present invention provides an optimized structure, by which the first stop block 34 is abutted against the top surface of the orifice plate 4 to realize positioning and fixation between the sealing ring 3 and the orifice plate 4. After the annular groove 22 breaks itself, the orifice plate 4 is prevented to touch with the anti-explosion slice 2 so as to avoid the short circuit of the anti-explosion battery cap 100; the second stop block 35 is abutted against the bottom surface of the orifice plate 4 to realize positioning and fixation between the sealing ring 3 and the orifice plate 4. After the annular groove 22 breaks itself, the first stop block 34 and the second stop block 35 are designed to prevent the orifice plate 4 from coining off from the sealing ring 3 so that the orifice plate 4 can be fixed in the sealing ring 3 without adding insulation sheets (not shown) which may cause the rise in cost. Therefore, the anti-explosion battery cap 100 can be improved in an ability of anti-short circuit with the optimized structure that maintains a constant cost.

What is claimed is:

1. An anti-explosion battery cap, including:
a top cover;
an anti-explosion slice, connected to the top cover;
a sealing ring, receiving the top cover and the anti-explosion slice, and including at least a first stop block and at least a second stop block, the first stop block arranged in an inner side of the sealing ring and extending inwardly to be located below the anti-explosion slice, the second stop block arranged in the inner side of the sealing ring and extending inwardly to be located below the first stop block, the first stop block and the second stop block arranged in parallel and staggered up and down; and
an orifice plate, received in the sealing ring and connected to the anti-explosion slice, the orifice plate located between the first stop block and the second stop block.

2. The anti-explosion battery cap of claim 1, wherein the top cover is disposed with a top surface, a bending portion, a first circular ring, a plurality of exhaust holes, an outer edge of the top surface is bended and extended obliquely to form the bending portion, a bottom of the bending portion is extended outwardly and connected to the first circular ring, the first circular ring is parallel to the top surface, the plurality of the exhaust holes form on the bending portion.

3. The anti-explosion battery cap of claim 2, wherein the anti-explosion slice is disposed with a first body, an annular groove, a second circular ring and a bent arm, the first body is provided with the annular groove, an outer edge of the first body is extended outwardly to form the second circular ring, an outer edge of the second circular ring is bended and extended upwardly and then bended and extended inwardly to form the bent arm, the bent arm envelops the first circular ring of the top cover.

4. The anti-explosion battery cap of claim 3, wherein an inner side of the second circular ring is bended inwardly and extended toward the orifice plate to form the first body, the first body is bulged toward the orifice plate as the arc-shaped plate structure, a centre of the first body is welded on the orifice plate, the annular groove is provided on a surface of the first body facing the orifice plate and formed adjacent to a junction of the first body and the second circular ring.

5. The anti-explosion battery cap of claim 4, wherein the sealing ring is disposed with an outer ring, a third circular ring, an inner ring, the first stop block, the second stop block and a positioning convex block, an inner side of the outer ring is attached with an outer side of the bent arm of the anti-explosion slice, a bottom of the outer ring is bended inwardly to form the third circular ring, the third circular ring is abutted against the second circular ring of the anti-explosion slice, an inner side of the third circular ring is extended downwardly to form the inner ring, a top of the inner side of the third circular ring forms the first stop block, the first stop block is abutted against a top surface of the orifice plate, a bottom of an inner side of the inner ring forms the second stop block, the second stop block is abutted against a bottom surface of the orifice plate, an inner side of the outer ring is extended inwardly to form the positioning convex block, the positioning convex block is abutted against the bent arm of the anti-explosion slice.

6. The anti-explosion battery cap of claim 5, wherein the orifice plate is disposed with a second body, a blind hole, several solder bumps, the second body is abutted against the first body of the anti-explosion slice, the blind hole is disposed on the second body, the solder bumps are disposed in the blind hole, the solder bumps connect a centre of the first body to the second body.
